(19) United States
(12) Patent Application Publication
(10) Pub. No.: US 2006/0073445 A1
(43) Pub. Date: Apr. 6, 2006

(54) Data collecting method and system

(75) Inventors: Anthony Zhou, Taipei (TW); Chaucer Chiu, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 10/988,022

(22) Filed: Nov. 12, 2004

(30) Foreign Application Priority Data
Sep. 30, 2004 (TW) 093129525

(51) Int. Cl. G09B 5/00

(52) U.S. Cl. 434/169

(57) ABSTRACT

A data collecting method and system suitably used in a device with word learning function are disclosed. The system provides users to self defined collecting conditions for test data, that is, collecting those words manually added by the users and automatically added when wrongly answered in tests, so as to construct a self-defined test bank to facilitate the memorization of words.

### FIELD OF THE INVENTION

The present invention relates to a data collecting method and system, and more particularly, to a data collecting method and system allowing self-defined words in a bank of test questions.

### DESCRIPTION OF THE PRIOR ART

Word learning tool, such as the translation software installed in a computer or portable electronic dictionary are becoming one of the indispensable tools in people's everyday work and learning environment. Word learning tool is adapted to different learning levels of users. Words are divided into several levels in advance, for example, words for junior high school level, words for senior high school level, commonly used words, TOFEL, and GRE etc. Spell test function is also provided to enhance users' memories to words. However, there exists a problem with this approach, that is when the user selects a certain test level, the test level contains all the words for that level. However, in practice, when the user selects a certain level to practice, he may already know some of the words in that level. Thus, known words are no longer required in the practices, only those words unfamiliar to the user need to be practiced. This approach obviously is not adapted to one's personal requirement, and also decreases learning efficiency and result.

Therefore, there exists a need for a custom bank of test questions defined according to different requirements of the users.

### SUMMARY OF THE INVENTION

In order to solve the problems of the prior art, a primary objective of the present invention is to provide a data collecting method and system. The system comprises a self-defined bank of test questions. User can collect those manually added words and words that users have not yet passed in tests into the bank of test questions. This enhances users' memories on these words.

In order to achieve the above and other related objectives, the present invention provides a data collecting method and system. The data collecting system is suitable for use in a device with a word learning function. The system comprises a database, a setup module, an identifying module, and an associating module. The database comprises a test bank for storing word data for testing, and a word bank for storing all words and their definitions. The setup module is used to set data collecting conditions for the test bank. The identifying module is used to identify words that match the collecting conditions set via the setting module and adding the matched word data to the test bank, and the associating module is used to search those definitions from the word bank of the words stored in the test bank by the identifying module and store the definitions in the corresponding locations of the test bank. The device can be a portable electronic device selected from the group consists of Personal Digital Assistance (PDA), a Handheld Pocket Computer (HPC), and an electronic dictionary. The device can also be a Personal Computer (PC) or a notebook (NB). The database can be an associating type database. The setup module sets those words manually inputted by the user or incorrectly answered in tests to be collected into the test bank.

The data collecting method is suitable for use in a device with word learning function. The method comprises the steps of: constructing a database, which comprises a test bank for storing test word data, and a word bank for storing all words and their definitions; providing a setup module for setting collecting conditions for data that construct the test bank; providing an identifying module for identifying words that match the collecting conditions set via the setting module and adding them to the test bank; and providing an associating module for searching those definitions from the word bank associated with the words stored in the test bank by the identifying module, and storing the definitions in the corresponding locations of the test bank.

In step (2) of the method, the setup module sets those words manually inputted by the user or incorrectly answered in tests to be collected into the test bank.

Using the data collecting method and system disclosed in the present invention, during words learning process, users can manually include those wanted words into the test bank. Users can also select those words that were incorrectly answered in tests to be added automatically into the test bank, so that the test contents are adapted to one's own needs, thereby increases users' memorization of words.

### BRIEF DESCRIPTION OF THE DRAWINGS

A better understanding of the present invention can be obtained when the forgoing detailed description is considered in conjunction with the following drawings, in which:

FIG. 1 shows a schematic block diagram for a data collecting system of the present invention.

FIG. 2 shows an operating flow diagram of the data collecting method of the present invention.

FIGS. 3A and 3B are operating diagrams for an embodiment of manually adding test words in the data collecting method according to the present invention.

FIG. 4 shows an operating diagram for an embodiment of setting automatically adding failed words in the data collecting method according to the present invention.

FIG. 5 shows a schematic diagram for an embodiment of selecting self-defined test bank for test in the data collecting method according to the present invention.

### DETAILED DESCRIPTION OF THE PREFFERED EMBODIMENT

The descriptions below of specific embodiments are to illustrate the present invention. Others skilled in the art can easily understand other advantages and features of the present invention from contents disclosed in this specification. The present invention can be carried out or applied through different embodiments. Every details of this specification can be modified based on different viewpoints and applications yet still within the scope of the present invention.

The data collecting system 10 of the present invention is suitable to be used in a device with word learning function. The device can be, for example, a PDA, a HPC, a portable electronic dictionary, a PC, or a NB etc.

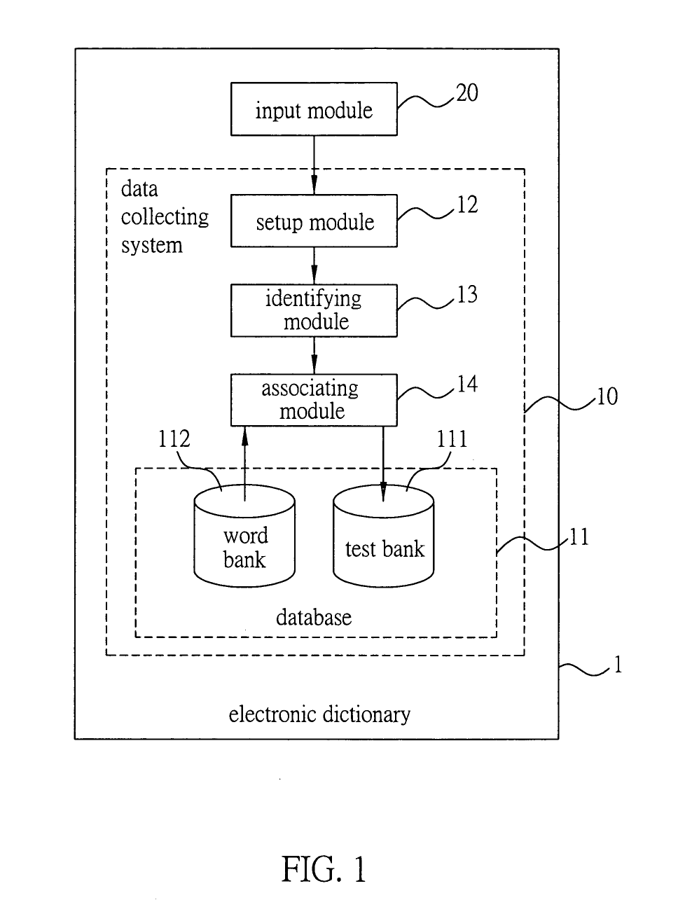

Referring to FIG. 1, a basic structure of a data collecting system 10 used in an electronic dictionary 1 is schematically shown. The electronic dictionary 10 comprises an input module 20, for example, a mouse, keyboard, a handwriting input board, or a touch pen etc. It should be noted that the electronic dictionary 10 further comprises other functions, however those functions that are conventional and standard for electronic dictionary will not be described in details, only those related to the present invention are shown.

The data collecting system 10 comprises a database 11, a setup module 12, an identifying module 13, and an associating module 14.

The database 11 is an associating type database. In this embodiment, the database 11 comprises a test bank 111 for storing words for test, and a word bank 112 for storing all words and their definitions. The definitions of the words include phonetic symbol, word class, explanation, exemplary sentence, and real person pronunciation. In this embodiment, the test bank 111 comprises small test banks divided according to levels such as “Primary School”, “Middle School”, “High School”, and “College”, and small test banks divided according to specific fields such as “TOFEL” and “GRE”. In the present embodiment, the test bank 111 refers specifically to a self-defined bank self-defined by the users.

In addition, in the present embodiment, the word data stored in test bank 111 and the word bank 112 can be mutually shared. That is, words stored in the word bank 112 can all be selected into the test bank 111 for test. It should be explained is that when a user selects a specific word into the test bank 111 and opens the test bank 111, only the contents of test bank 111 are shown during test or words browsing process.

The setup module 12 is used to setup the related collecting conditions for data that construct the test bank 111. In this embodiment, user can define the source of data composing the test bank 111 via setup module 12 using two approaches. One is that the user manually includes required words into the test bank 111. The other approach is that the failed words can be automatically added into the test bank 111.

The identifying module is used to identify those words that match the collecting conditions set via setup module 12. In this embodiment, the identifying module 13 stores those words added manually by the user or failed in tests into the test bank 111 for targeted repeating practices in the future.

The associating module 14 searches the definitions and related data from the word bank 112 of those words stored in the test bank 111 by the identifying module 13, and stores those data in the correspond locations of the test bank 111. Furthermore, data correlation can be performed in an index manner. In word bank 112, each word entry has a unique index number. The identifying module 13 stores the index number corresponding to the word in the test bank 111. When in test, the associating module 14 fetches the corresponding word data for test from the word bank 112 according to the index number stored in the test bank 111.

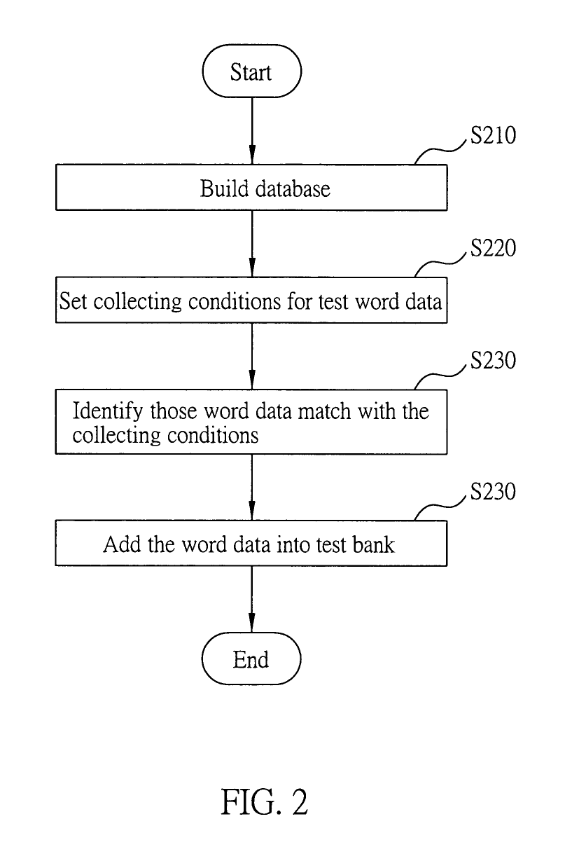

FIG. 2 shows an operating flow diagram of the data collecting method of the present invention. In this embodiment, the data collecting method can be applied to an electronic dictionary 1. Firstly in step S210, a self-defined test bank 111 for users is constructed in advance. The test bank 111 is used to store word-related data for test. The word bank 112 is the word bank of the electronic dictionary 1. The word bank 112 and the test bank 111 are dynamically associated. Then proceed to step S220.

In step S220, a setup module 12 is provided to the users for setting collecting conditions for related data of the test bank 111. In this embodiment, it sets those words manually added by the user or those words failed in tests to be collected by the test bank 111. Then proceeds to step S230.

In step S230, an identifying module 13 is provided to identify those word data that match the collecting conditions set via the setup module 12. In this embodiment, the identifying module 13 identifies those word data added manually by the user via input device 20 or those failed in tests, and adds the word data into the test bank 111. Then, proceeds to step S240.

In step S240, an associating module 14 is provided for searching the definitions in the word bank 112 corresponding to the words identified by the identifying module 13, and storing the definitions in the corresponding locations of the test bank 111 for future practice.

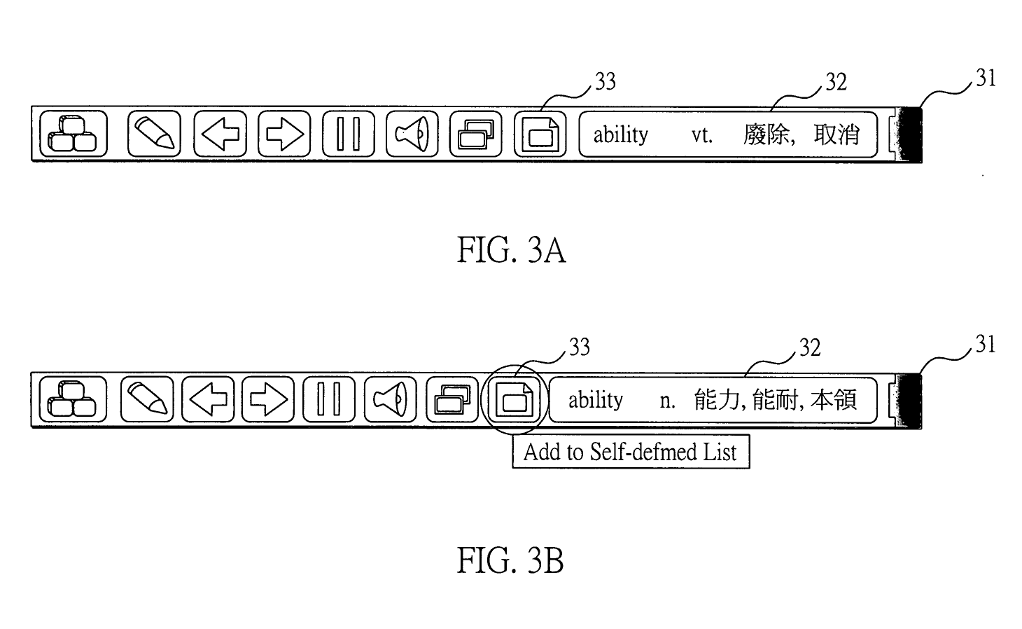

FIGS. 3A and 3B are operating diagrams for an embodiment of manually adding test words in the data collecting method according to the present invention. FIG. 3A shows a tool bar 31. The definitions corresponding to a word entry can be shown in the data display section 32. That is, “ability”, which has a class “n”, meaning “ [symbol] , [symbol] , [symbol] ”. There is also an “Auto add” button 33 on the tool bar 31. As shown in FIG. 3B, when user is learning the word “ability”, and he/she may use move the input device 20, such as a mouse, over the “Auto add” button 33, there will be an automatic pop-up showing “Add to Self-defined List”. If the user presses down the button 33, the word “ability” shown in the data display section 32 will be added to the self-defined test bank.

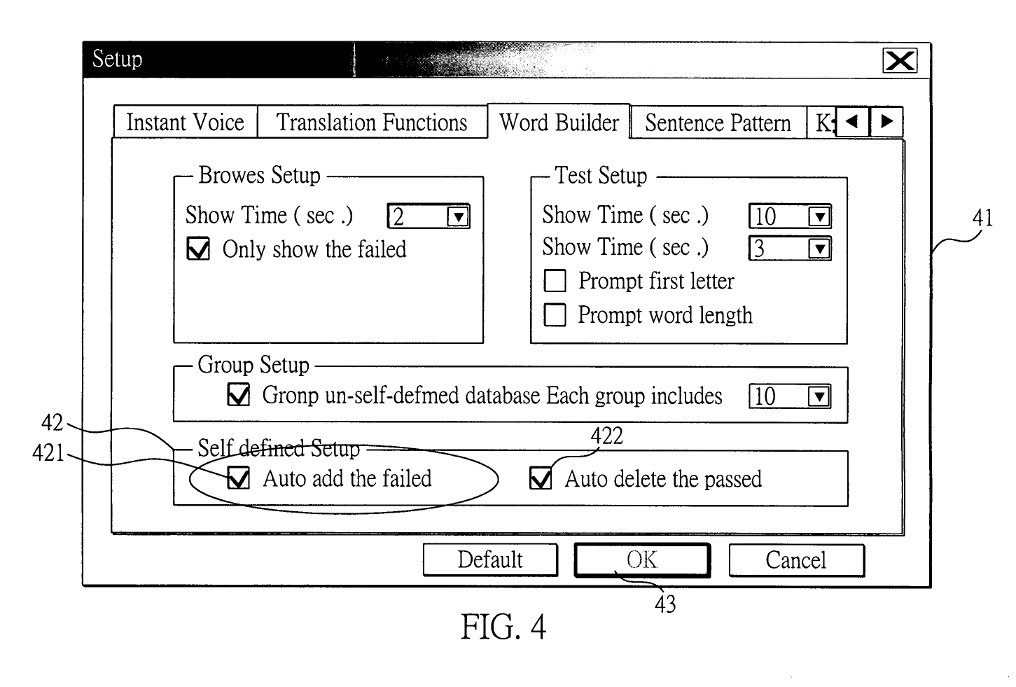

FIG. 4 shows an operating diagram for an embodiment of setting automatically adding failed words in the data collecting method according to the present invention. As shown in FIG. 4, in the setup interface 41, there is a “Self-defined Setup” 42, and in the “Self-defined Setup” 42, there are two tick boxes. That is, an “Auto add the failed” box 421 and an “Auto delete the passed” box 422. If user ticks the “Auto add the failed” box 421, then during word test, all those failed words will be automatically added into the self-defined test bank 111. If the user also ticks the “auto delete the passed” box 422, then when he/she selects the self-defined test bank 111 for word test, all the passed words will be deleted. Finally, user can store these settings by pressing down the “OK” button 43.

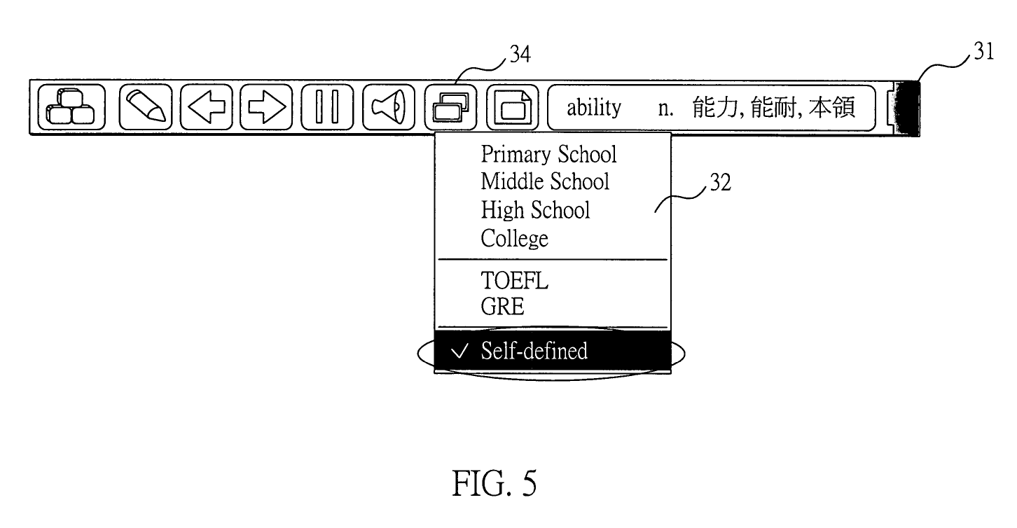

FIG. 5 shows a schematic diagram for an embodiment of selecting self-defined test bank for test in the data collecting method according to the present invention. There is shown a level select button 34. When the user selects the level select button 34, a drop down menu 341 will appear, containing levels of “Primary School”, “Middle School”, “High school”, “College”, “TOFEL”, “GRE”, and “Self-defined” for selection. User can select the category of “Self-defined” and run the test program, he/she can do the test tailored to user's own needs. It should be noted that there could be several self-defined test banks 111 defined according to user's requirement.

In summary, the data collecting method and system of the present invention provide users with a self-defined test banks for collecting those words manually added by the users or the words failed in tests, so that users can enhance their memories for those unfamiliar or wrongly answered words. This allows a word learning process more tailored to individual needs, thus possesses an improvement.

The embodiments described above are only to illustrate aspects of the present invention; it should not be construed as to limit the scope of the present invention in any way.

While the invention has been described in detail with reference to specific embodiments thereof, it will be apparent in the art that various changes and modifications can be made, and equivalents employed, without departing from the scope of the claims.

What is claimed is:

1. A data collecting system suitable for use in a device with a word learning function, the system comprising:
a database comprising a test bank for storing word data for testing, and a word bank for storing words and definitions thereof;
a setup module used to set collecting conditions for related data that construct the test bank;
an identifying module used to identify words that match the collecting conditions set via the setup module and adding the identified word data to the test bank, and
an associating module used to search the definitions from the word bank corresponding to the words stored in the test bank by the identifying module and store the definitions in the corresponding locations of the test bank.

2. The system as claimed in claim 1, wherein the device is a portable electronic device.

3. The system as claimed in claim 1, wherein the database is an associating type database.

4. The system as claimed in claim 1, wherein the setup module sets those words manually inputted by the user or incorrectly answered in tests to be collected into the test bank.

5. The system as claimed in claim 1, wherein the definitions of the words comprise phonetic symbols, explanations, class, exemplary sentence, and pronunciation of the words.

6. The system as claimed in claim 1, wherein the word data stored in the test bank and the word bank are mutually shared, and when a user selects specific words into the test bank and opens the test bank, during testing or browsing stage, only the contents of the test bank are shown.

7. A data collecting method suitable for use in a device with word learning function, the method comprising the steps of:
(1) constructing a database which comprises a test bank for storing word data for test and a word bank for storing all words and their definitions;
(2) providing a setup module for setting collecting conditions for related data that construct the test bank;
(3) providing an identifying module for identifying words that match the collecting conditions set via the setting module and adding the identified word data into to the test bank; and
(4) providing an associating module for searching the definitions from the word bank corresponding to the words stored in the test bank by the identifying module, and storing the definitions in the corresponding locations of the test bank.

8. The method as claimed in claim 7, wherein the device is a portable electronic device.

9. The method as claimed in claim 7, wherein the database is an associating type database.

10. The method as claimed in claim 7, wherein the definitions of the words comprise phonetic symbols, explanations, class, exemplary sentence, and pronunciation of the words.

11. The method as claimed in claim 7, wherein in step (2), the setup module sets those words manually inputted by the user or incorrectly answered in tests to be collected into the test bank.

12. The method as claimed in claim 7, wherein the word data stored in the test bank and the word bank are mutually shared, and when a user selects specific words into the test bank and opens the test bank, during testing or browsing stage, only the contents of the test bank are shown.
